(19) United States
(12) Patent Application Publication
(10) Pub. No.: US 2006/0119580 A1
(43) Pub. Date: Jun. 8, 2006

(54) OPTICAL MOUSE

(76) Inventor: Mao-Hsiung Chien, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,395

(22) Filed: Aug. 2, 2005

(30) Foreign Application Priority Data
Dec. 7, 2004 (TW) 093137815

(51) Int. Cl. G09G 5/08

(52) U.S. Cl. 345/166

(57) ABSTRACT

An optical mouse includes a light source, a lens, a first reflecting surface, a second reflecting surface, a rounded surface, and a sensor. A light beam generated by the light source is focused by the lens, sequentially reflected by the first and second reflecting surfaces, and finally refracted by the rounded surface and projected onto a plane. The light projected onto the plane is then scattered to the sensor so as to control the operation of the optical mouse.

### BACKGROUND OF THE INVENTION

1. Field of the Invention

The present invention relates to an optical mouse, and more particularly, to an optical mouse capable of improving a light-condensing effect by using a rounded surface.

2. Description of the Prior Art

Please refer to FIG. 1, which is a structure of an optical mouse 10 according to the prior art. The optical mouse 10 comprises a light source 11, a convex lens 13, two reflecting surfaces 12 and 15, a refracting surface 14, and a sensor 17. The light source 11 generates light; the convex lens 13 focuses light; the reflecting surfaces 12, 15 and the refracting surface 14 direct light generated by the light source 11 to a plane 19; and the sensor 17 receives light scattered by the plane 19 to control the operation of the optical mouse 10.

In the light path shown in FIG. 1, light generated by the light source 11 becomes a beam via the convex lens 13 and is then projected to the reflecting surface 15. Next, the reflecting surface 15 and 12 sequentially reflect the beam. Finally, the refracting surface 14 refracts the beam and projects it onto the plane 19.

When a reflection is performed on the beam, since each reflecting surface and the refracting surface are flat, the light-condensing effect inside the prism is not noticeable. In other words, suppose that the entire energy of the beam traveling through the lens 13 is constant. If the width of the beam is narrower, its light strength is larger. On the contrary, if the width of the beam is wider, its light strength is smaller. Therefore, from the light path of FIG. 1, when the beam reflected by the reflecting surface 12 travels to the refracting surface 14, the width of the beam becomes narrow, meaning that its light strength becomes weak. After the beam is reflected twice inside the prism, its light strength is attenuated relatively. Finally, the beam is refracted by the refracting surface 14, and its light strength is not enhanced at all. If a light area projected onto the plane 19 is wider, that is, the width of the refracted beam is wider; its light strength is relatively weaker. Or, if the optical mouse 10 operates in a poor light-reflecting or scattering condition, for example, the optical mouse 10 operates on a glass plate; since background light is stronger and the light area A1 projected onto the plane 19 is wider, the light strength received by the optical mouse 10 is much weaker. This could result in an erroneous detection of rough and uneven features of the plane 19.

As mentioned above, the light strength received by the optical mouse 10 has great influence on the sensitivity of the optical mouse 10. The light strength is related to the width of the beam or the light area. The narrower width of the beam, the stronger light strength.

### SUMMARY OF THE INVENTION

It is therefore a primary objective of the claimed invention to provide an optical mouse to solve the above-mentioned problem.

The claimed invention discloses an optical mouse comprising a light source, a lens, a first reflecting surface, a second reflecting surface, a rounded surface, and a sensor for sensing light scattered by a plane. The light source projects a light beam, the lens focuses the light beam, the first reflecting surface reflects light focused by the lens, the second reflecting surface reflects light reflected by the first reflecting surface, and the rounded surface directs light reflected by the second reflecting surface to the plane.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a structure of an optical mouse according to the prior art.

FIGS. 2 to 4 are different embodiments of optical mice based on the present invention.

### DETAILED DESCRIPTION

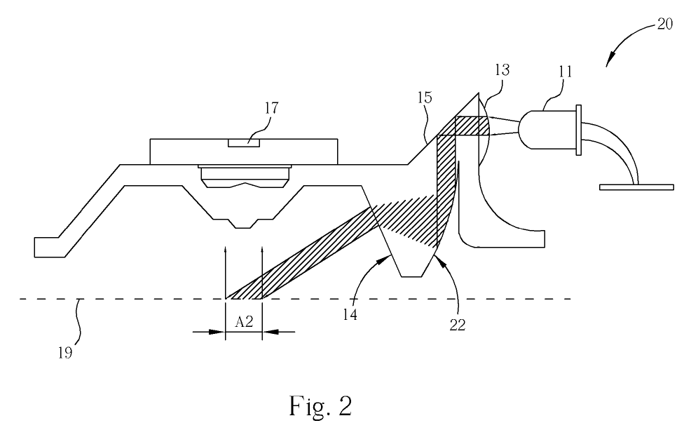

Please refer to FIG. 2, which is a first embodiment of the present invention optical mouse 20. The optical mouse 20 comprises a light source 11, a lens 13, a reflecting surface 15, a rounded surface 22, a refracting surface 14, and a sensor 17. The light source 11 projects light; the lens 13 focuses light; the reflecting surface 15, the rounded surface 22, and the refracting surface 14 can direct light generated by the light source 11 to a plane 19; and the sensor 17 receives light scattered by the plane 19 so as to control the operation of the optical mouse 20.

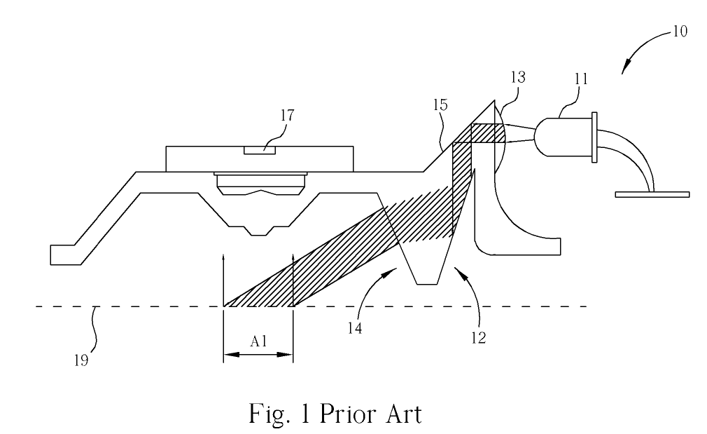

In the light path in FIG. 2, light projected by the light source 11 becomes a beam via the lens 13 and is projected to the reflecting surface 15. Next, the beam reflected by the reflecting surface 15 travels downward to the rounded surface 22. Note that the light path from the light source 11 to the rounded surface 22 is identical to the light path from the light source 11 to the reflecting surface 12 of FIG. 1, and therefore the light strength and the widths of these segments in FIGS. 1 and 2 are the same. However, after the reflection of the rounded surface 22, the original beam becomes a narrow beam as shown in FIG. 2, meaning that the light strength is enhanced. Finally, the beam is refracted by the refracting surface 14 and is projected onto the plane 19.

Compared to the light path of FIG. 1, the rounded surface 22 of FIG. 2 can condense the original beam traveling inside the prism into a narrower beam. The present invention enhances the light strength by collecting the beam to compensate for double reflection inside the prism resulting in light strength attenuation. Additionally, since the beam inside the prism becomes narrow, the light area A2 projected onto the plane 19 is smaller than the light area A1 of FIG. 1, meaning that the light strength received by the optical mouse 20 is stronger.

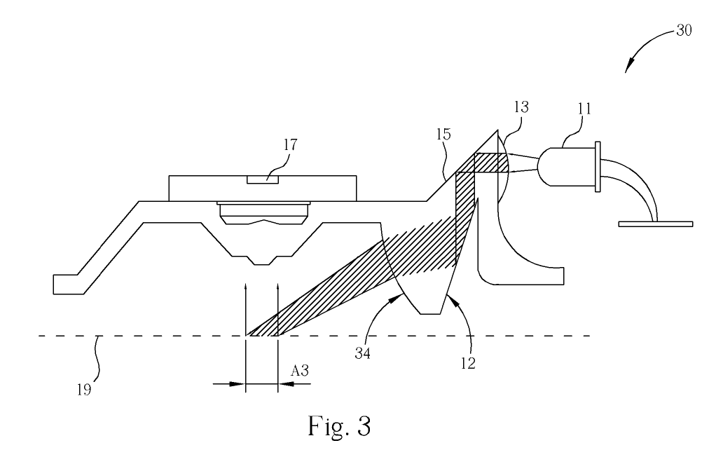

Please refer to FIG. 3, which is a second embodiment of an optical mouse 30 based on the present invention. The optical mouse 30 utilizes the flat refracting surfaces 15 and 12. A key difference is that the refracting surface 14 is replaced with a rounded surface 34. The light path of FIG. 3 before refraction is identical to that of FIG. 1. In this embodiment, the beam is finally refracted by the rounded surface 34, which can narrow the beam so that the light area A3 projected onto the plane 19 is smaller than the light area A1 of FIG. 1, thereby increasing light strength. This embodiment also solves light strength attenuation in the prior art.

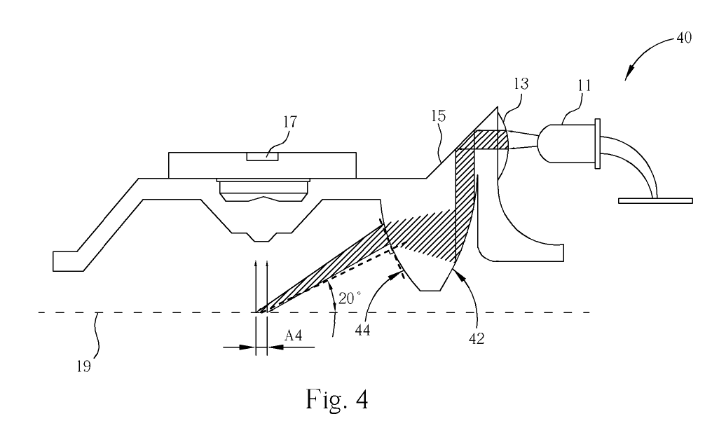

The present invention can also include a rounded rather than planar reflecting surface so as to enhance light strength or narrow the beam inside the prism. Please refer to FIG. 4, which is a third embodiment of an optical mouse 40 according to the present invention. The optical mouse 40 utilizes two rounded surfaces 42 and 44 to achieve a light-condensing effect. First, the beam reflected by the refracting surface 15 travels to the rounded surface 42. The light path of reflection of the rounded surface 42 is identical to that of reflection of the rounded surface 22 of FIG. 2, colleting the beam to enhance light strength. Then the collected beam travels to the rounded surface 44. Before the beam travels through the prism and is projected onto the plane 19, the beam is narrowed again by refraction of the rounded surface 44, further collecting the beam to narrow the width or light area of the beam. Compared to the embodiments of FIGS. 2 and 3, the embodiment of FIG. 4 can project a much narrower beam onto the plane 19 resulting in much smaller light area A4 with relatively stronger light strength. Thus, the best embodiment is the one of FIG. 4. Additionally, in FIG. 4, an angle between a normal of maximum curvature of the rounded surface 44 and the plane 19 is about 20 degrees, which offers good light-condensing performance.

In each embodiment, the lens 13 is a convex lens and the light source 11 is a light-emitting diode (LED). The prism comprising reflecting surfaces and a refracting surface can be another prism or lens capable of collecting light, and is made by plastic injection press molding or glass grinding. The best choice for a rounded surface is a paraboloid.

In contrast to the prior art, the present invention provides rounded reflecting and refracting surfaces to collect and condense the light beam inside the prism and narrow the beam so as to reduce light strength attenuation. Thus, the optical mouse of the present invention can receive stronger reflected light which offers better movement resolution sensitivity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical mouse comprising:
a light source for projecting a light beam;
a lens set comprising:
a lens for focusing the light beam;
a first reflecting surface for reflecting light focused by the lens;
a second reflecting surface for reflecting light reflected by the first reflecting surface; and
a rounded surface for directing light reflected by the second reflecting surface to a plane; and
a sensor for sensing light scattered by the plane.

2. The optical mouse of claim 1, wherein the second reflecting surface is a rounded surface.

3. The optical mouse of claim 1, wherein the second reflecting surface is a plane.

4. The optical mouse of claim 1, wherein an angle between a normal of maximum curvature of the rounded surface and the plane is about 20 degrees.

5. The optical mouse of claim 1, wherein the first reflecting surface is a plane.

6. The optical mouse of claim 1, wherein the lens is a convex lens.

7. The optical mouse of claim 1, wherein the light source is a light-emitting diode.

8. An optical mouse comprising:
a light source for projecting a light beam;
a lens set comprising:
a lens for focusing the light beam;
a reflecting surface for reflecting light focused by the lens;
a rounded surface for collecting and reflecting light reflected by the reflecting surface; and
a refracting surface for refracting light reflected by the rounded surface to a plane; and
a sensor for sensing light scattered by the plane.

9. The optical mouse of claim 8, wherein the reflecting surface is a plane.

10. The optical mouse of claim 8, wherein the refracting surface is a plane.

11. The optical mouse of claim 8, wherein the lens is a convex lens.

12. The optical mouse of claim 8, wherein the light source is a light-emitting diode.
